(19) United States
(12) Patent Application Publication
(10) Pub. No.: US 2002/0120531 A1
(43) Pub. Date: Aug. 29, 2002

(54) Method and system for collecting footwear manufacturing data

(76) Inventor: Jarno Fonsen, Pomarkku (FI)

Correspondence Address: YOUNG & THOMPSON, 745 SOUTH 23RD STREET 2ND FLOOR, ARLINGTON, VA, 22202

(21) Appl. No.: 10/078,446

(22) Filed: Feb. 21, 2002

Related U.S. Application Data
(63) Continuation of application No. PCT/FI00/00749, filed on Sep. 6, 2000.

(30) Foreign Application Priority Data
Sep. 7, 1999 (FI) 19991904

(51) Int. Cl. G06F 17/60

(52) U.S. Cl. 705/26

(57) ABSTRACT

A method and a telecommunication system for transmitting individually specified customer information necessary for manufacturing footwear, the customer information comprising at least customer ID, ID on the footwear to be manufactured, and feet measurement information. The telecommunication system comprises a foot scanner for defining the measurement information on the customer's feet, a first terminal connected to the foot scanner for receiving the customer identification information and said feet measurement information in the telecommunication system. The first terminal establishes a telecommunication connection to a data system of the footwear manufacturer, and stores the customer ID and the feet measurement information in a customer database. The telecommunication system further comprises a second terminal arranged to establish a telecommunication connection to the footwear manufacturer through a public telecommunication network, such as the Internet.

This application is a Continuation of International Application PCT/FI00/00746 filed on Sep. 6, 2000, which designated the U.S. and was published under PCT Article 21(2) in English.

The invention relates to manufacturing footwear on the basis of individually specified customer information, and particularly to an arrangement for collecting said customer information.

Footwear has typically been mass-produced, which means that each shoe model is produced in large quantities using particular predetermined sizes and last models. In view of the conventional manufacturing technology, it is preferable if the styles, sizes and last models vary as little as possible, which, in terms of cost-efficiency, enables sufficiently large quantities and adequately small tolerances in measurements. From a customer's viewpoint, however, this is not advantageous since, particularly owing to standard sizes and last models, it may be difficult to find a pair of shoes to precisely fit the customer's feet.

As well known, Footwear can also be custom-made. The feet of the customer are then manually measured in order to obtain the necessary measurements for manufacturing the footwear by utilizing a unique size and last. Typically, such footwear is a unique pair of shoes manufactured mainly by hand, which means a longer manufacturing process and higher costs. If the customer then wishes to purchase custom-made footwear at another store, the slow and laborious process of measuring the feet has to be repeated.

With the advent of more sophisticated computer-aided design and scanning techniques, various automatized foot measuring methods have recently been developed. U.S. Pat. No. 5,128,880 discloses an electro-optical foot scanner and a method of scanning the foot. The essential measurements of a customer's feet are defined by using a scanner provided in a retail store, and the information thus obtained is stored in the memory of the scanner. Furthermore, information on the desired footwear style and customer identification may also be stored in the memory. The scanner in the retail store has also been arranged to communicate with the data systems of the footwear manufacturing process, the data systems receiving enquiries and orders. The measurements of the customer's feet can be compared to the standard sizes and last models used in the manufacturing process, and if no suitable standard sizes are found in the process, the footwear can be manufactured by using a personal size and last. Enquiries can also be made to find out e.g. the stock level of a particular size of a given model. As to the manufacturing, the production process can be controlled based on placed orders, and it is also possible to compute statistical trends in order to predict the demand for each model and subsequent optimal production lots. On the basis of the unique measurement information in the placed orders, control information is fed to CAD/CAM machines used in the manufacturing process, which enable the production management to be flexibly arranged also according to the individually varying measurements.

From both the footwear manufacturer's and the customer's viewpoints, a problem in the above-described arrangement is the dependency of the system on the retail store. The customer's feet are measured at a certain retail store, and the custom-specific information is stored in the data system of this store. If the customer wishes to purchase footwear at another retail store, the process of measuring the feet and storing and modifying the information has to be repeated. The footwear is also delivered to the customer through said retail store, which makes the delivery arrangements more complex and also increases the price if the store is located elsewhere in the country or even abroad. Similarly, the last models individually manufactured according to the customer's feet are delivered either to the retail store or to the customer, who can utilize said model for placing further orders of suitable footwear. This also makes it more difficult for the customer to do business with another retail store. The aforementioned difficulties undergone by the customer are also problems for the footwear manufacturer since they may make the customer less loyal to brand.

An object of the invention is thus to provide a method and apparatus implementing the method so as to enable the above-mentioned problems to be alleviated. The objects of the invention are achieved with a method of transmitting individually specified order details necessary for manufacturing footwear in a telecommunication system, the order details comprising at least customer identification information, identification information on the footwear to be manufactured, and feet measurement information, the method comprising defining the measurement information on the customer's feet by using a foot scanner, receiving the customer identification information and said feet measurement information by means of a first terminal operatively connected to the foot scanner, and establishing a telecommunication connection from the first terminal to a data system of the footwear manufacturer. The method is characterized by

the telecommunication system further comprising a second terminal arranged to establish a telecommunication connection to the data system of the footwear manufacturer,

storing said customer identification information and said feet measurement information in a customer information database located in the data system of the footwear manufacturer, and

receiving, in said data system, the identification information specified by the customer on the footwear to be manufactured through the telecommunication connection established by said first or said second terminal.

The invention also relates to a telecommunication system for transmitting individually specified order details necessary for manufacturing footwear, the order details comprising at least customer identification information, identification information on the footwear to be manufactured, and feet measurement information, the telecommunication system comprising at least one foot scanner for defining the measurement information on the customer's feet, a first terminal operatively connected to the foot scanner for receiving the customer identification information and said feet measurement information in the telecommunication system, the first terminal being arranged to establish a telecommunication connection to a data system of the footwear manufacturer. The telecommunication system of the invention is characterized in that

said first terminal is arranged to store said customer identification information and said feet measurement information in a customer database located in the data system of the footwear manufacturer,

the telecommunication system further comprises a second terminal arranged to establish a telecommunication connection to the data system of the footwear manufacturer, and

the telecommunication system comprises software means for transmitting the identification information specified by the customer on the footwear to be manufactured through the telecommunication connection established by said first or said second terminal to said data system.

Preferred embodiments of the invention are disclosed in the dependent claims.

The idea underlying the invention is that the measurement information on the customer's feet and the customer identification information are stored in the data system of the footwear manufacturer, and the customer can later establish a telecommunication connection thereto so as to transmit footwear orders. The data system of the footwear manufacturer comprises essential information on the customer and the proper shoe size and last model for the customer, in which case for placing an order, it will suffice that the customer specifies the rest of the identification information on the desired footwear from, for example, a home computer through a telecommunication connection established via the Internet, or at an outlet communicating with the data system of the footwear manufacturer.

From the customer's viewpoint, an advantage of the method and system of the invention is that the customer can order desired custom made footwear independently of time and place when the customer's feet have once been measured by using the foot scanner and when the measurement information and the customer identification information have been stored in the database of the footwear manufacturer. The customer is independent of retail outlets, their location and opening hours. The customer can at any one time establish a telecommunication connection to the data system of the manufacturer to place orders from, for example, a home computer through an Internet connection. Nor does the customer have to store any customer information or the last model for himself or herself; for placing a new order of footwear, it will suffice that the registered customer knows his or her user name and password. The procedure of the invention is advantageous also from the footwear manufacturer's viewpoint. The manufacturer has, collected in one place, information on all the customers, their feet measurement information and the shoe models and variations thereof frequently required by the customers, which makes it easier to optimise the production. The procedure increases customer loyalty since the customer can be confident that the footwear will fit. The fact that there is less retail sale in the distribution stage enables the manufacturers' profits to be increased.

The invention is now described in closer detail in connection with the preferred embodiments and with reference to the accompanying drawings, in which

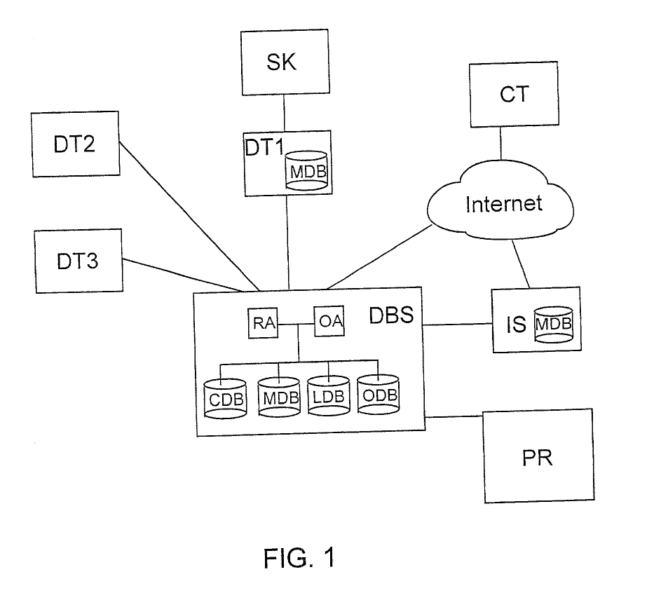

FIG. 1 is a simplified block diagram showing the structure of a telecommunication system of the invention, and

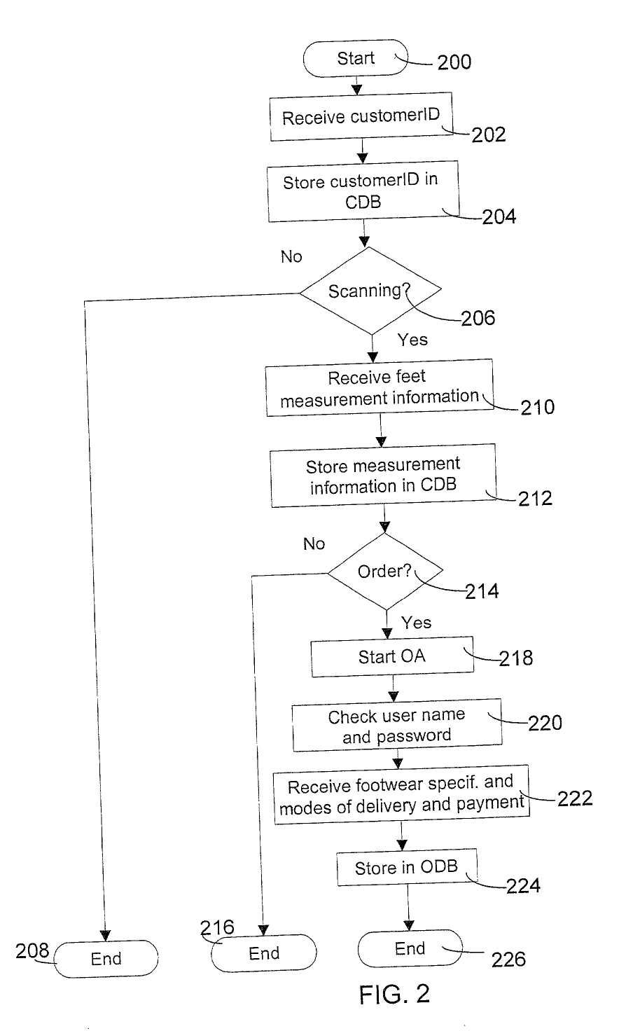

FIG. 2 is a flow diagram showing a procedure according to a preferred embodiment of the invention for feeding necessary information seen from the point of view of a manufacturer's database.

FIG. 1 is a simplified block diagram showing the structure of a data system according to the invention. A customer's feet are measured at an outlet equipped with a prior art foot scanner SK known per se. Both the customer's feet are measured by the foot scanner SK, after which a data system programmed in the foot scanner computes reference points for both feet essential to the footwear manufacturing process. The measurement data containing the reference points is transferred from the foot scanner SK to a dealer terminal DT1 at an outlet, such as a terminal in a telecommunication network or a PC connected to a telecommunication network. By the dealer terminal DT1, preferably by a registration application RA used therein, customer identification information, which may preferably comprise the customer's user name and password, name and other necessary contact details, is added to the feet measurement data. Identification information on the outlet and the foot scanner may also be added to the customer information for paying commissions or monitoring the operation of the foot scanner, for example. Preferably, all dealer terminals DT1, DT2, DT3, . . . in the data system of the invention are arranged to establish a telecommunication connection to a database server DBS of the manufacturer, the aforementioned feet measurement data and the customer identification information being stored in a customer information database CDB in the database server DBS. The dealer terminals DT can use the registration application RA either directly from the database server DBS run over the telecommunication connection, or the registration application RA can be stored in each dealer terminal DT, in which case the registration application is arranged to store the feet measurement data and the customer identification information directly in the customer information database CDB. Alternatively, the customer may already have registered in the data system of the invention either at an outlet in the system or by using a customer terminal CT communicating with a public telecommunication network, such as the Internet, in which case the customer identification information already exists. The database server DBS preferably also comprises the same customer information registration application as the terminals at the outlets do, so the customer is able to register by establishing a connection directly to the database server DBS. As far as the implementation of the invention is concerned, the order in which the customer identification information is fed and the feet measurement data is obtained is irrelevant since the two pieces of information must be stored before an order can be placed.

The database server DBS preferably further comprises a last database LDB comprising information on existing last models. The customer's feet measurement data is compared to the existing last models and a suitable last model matching the customer's measurements is selected for the customer. If no suitable last exists among the existing last models, the reference points in the feet measurement data are used for providing control information to be used by an automatic lathe for producing a suitable last. The information on a suitable last, either an existing one or one to be custom-made, is also stored in the customer information database CDB. All customer information is preferably stored directly in the database maintained by the manufacturer, in which case the identification information and feet measurement data on a particular customer are independent of a certain outlet and the databases thereof.

When the necessary customer identification information and feet measurement information have been stored in the customer database CDB, the desired shoe model can be selected and an order can be placed. The order can be placed either by using an order application OA in the dealer terminal DT at the outlet or by establishing a connection from the private terminal CT in the telecommunication network through a public telecommunication network to the database server DBS comprising a corresponding order application OA. The order application is started by feeding the customer's user name and password, after which the customer selects the desired shoe model. The database server DBS preferably comprises a model database MDB comprising information on different shoe models, and the information can be browsed by means of the order application OA. The model database MDB may also be stored in connection with the dealer terminal DT at the outlet and in a separate server IS providing public Internet service and comprising a home page of a business enterprise displaying different shoe models. The models can then be freely browsed; neither registering as a customer nor feeding user names are required. The customer can then have already browsed the models and decided on the desired shoe model. Furthermore, different shoe models may also be displayed at the outlet.

Depending on the shoe model, the customer can specify the sole (e.g. rubber or leather sole), colour, upper material and lining material of the desired model. In addition, the customer's name can be printed on e.g. the sole lining or it can be attached by a separate plate. In some models, the customer's monogram can also be printed on the upper lining. The customer may also choose whether the finished footwear is mailed directly to his or her home address or to an outlet in the system. From the order application OA, the customer selects preferred properties of the footwear to be ordered, whereby the price of the footwear to be ordered becomes updated and can, correspondingly, be viewed from the order application OA. When the customer has specified and accepted the properties of the desired footwear and also specified the modes of delivery and payment, the order application OA stores the order in the order database ODB in the database server DBS. The customer identification information and feet measurement information are copied from the customer database CDB to the order details.

The order database ODB can be used for controlling and optimizing the footwear production PR. In addition to the different properties of the desired shoe model, the order details also comprise information on the size and the last of the footwear. The upper and the lining of the footwear are cut by using an automatic cutter; therefore, the materials have to be dimensioned to match a particular size and last by using, for example, 3-D CAD programs known per se. Before starting the production, the process can then wait until a sufficient number of similar orders has been reached. Preferably, however, the waiting time cannot exceed a predetermined limit but the production will always be started before the limit is reached, which is to guarantee an adequately short delivery time as far as the customer is concerned. Completed and settled orders are delivered to the customer as chosen by himself or herself.

The procedure for feeding information according to a preferred embodiment of the invention is further illustrated from the point of view of the manufacturer's data system by means of the flow diagram of FIG. 2. The procedure starts by registering a customer in the data system, i.e. by feeding customer identification information to the data system (202), the information being stored in the customer database CDB (204). Next, the customer's feet are scanned (206), or, alternatively, feeding the information can also be interrupted at this stage (208) and the process can return to the scanning at a later stage. The feet measurement information obtained from the scanning (210) is preferably compared to information on the existing last models in the last database LDB, and a suitable last, which can be an existing last model or a new custom-made last model, is defined for the customer. The feet measurement information and the last model information are also stored in the customer database CDB (212). As already stated, the customer identification information and the feet measurement information may also be fed in reverse order.

Next, an order is made out according to the information specified by the customer (214). Feeding the information can be interrupted (216) also at this stage if the customer does not want to place the order at the same time but wants to order the footwear later. To make out the order, the order application OA is first started (218), which checks the identity of the customer by means of the user name and the password (220). The customer feeds the desired footwear specifications, modes of delivery and payment (222), and accepts the order. The order application OA attaches the necessary information from the customer database CDB to the order details and stores the order in the order database ODB (224).

The data system according to the invention provides great advantages over the prior art solutions as far as both the customer and the footwear manufacturer are concerned. When the customer's feet have once been measured with the foot scanner and when the measurement information and the customer identification information have been stored in the database of the footwear manufacturer, the customer can order desired custom-made footwear independently of time and place; it will suffice that the customer has means at hand for establishing a telecommunication connection to the order application OA maintained by the manufacturer. Furthermore, the customer or the outlet does not have to store any customer information or last model but for placing an order, it will suffice that the registered customer knows his or her user name and password. The method of the invention is particularly well suited for ordering custom-made footwear since the footwear can typically be purchased on the basis of a mere image if the customer can be sure that the footwear will be of the correct size and last. The foot size particularly of an adult does not substantially vary with time, whereas potential changes in sizes in clothes make the procedure of the invention much more difficult to apply to manufacturing clothes, for example. As far as the footwear manufacturer is concerned, the reduced dependency on each outlet according to the invention is also advantageous. The manufacturer has information on all the customers, their feet measurement information and the shoe models and variations thereof frequently required by the customers, which makes it easier to optimise the production. Customer loyalty will be increased since the customer can be confident that the footwear will fit, and, on the other hand, the fact that there is less retail sale in the distribution stage enables the manufacturers' profits to be increased.

It is obvious to one skilled in the art that as technology advances, the basic idea of the invention can be implemented in many different ways. The invention and the embodiments thereof are thus not restricted to the examples described above but they can vary within the scope of the claims.

What is claimed is:

1. A method of transmitting individually specified order details necessary for manufacturing footwear in a telecommunication system, the telecommunication system comprising a first terminal and a second terminal arranged to establish a telecommunication connection to a data system of a footwear manufacturer, the order details comprising at least customer identification information, identification information on the footwear to be manufactured, and feet measurement information, the method comprising
defining the measurement information on the customer's feet by using a foot scanner,
receiving the customer identification information and said feet measurement information by means of a first terminal operatively connected to the foot scanner,
establishing a telecommunication connection from the first terminal to a data system of the footwear manufacturer,
storing said customer identification information and said feet measurement information in a customer information database located in the data system of the footwear manufacturer, and
receiving, in said data system, the identification information specified by the customer on the footwear to be manufactured through the telecommunication connection established by said first or said second terminal.

2. A method as claimed in claim 1, wherein said data system comprises a last database comprising essential information on last models to be manufactured, further comprising
comparing the feet measurement information received from the foot scanner to the last models in the last database, and, alternatively,
storing the information on a suitable last model in the customer database in response to the fact that the last database comprises a last model to match said feet measurement information, or
controlling the data system to define a new last model and to store the information on the new last model in the customer database and in the last database in response to the fact that no last model is found in the last database to match said feet measurement information.

3. A method as claimed in claim 1, further comprising
presenting alternative identification information on the footwear to be manufactured to the customer for the specification by means of said first or said second terminal.

4. A method as claimed in claim 1, wherein
said second terminal is arranged to establish a telecommunication connection to the data system of the footwear manufacturer through a public telecommunication network, such as the Internet.

5. A telecommunication system for transmitting individually specified order details necessary for manufacturing footwear, wherein
the telecommunication system comprises at least one foot scanner for defining the measurement information on the customer's feet, a first terminal operatively connected to the foot scanner for receiving the customer identification information and said feet measurement information in the telecommunication system, a second terminal arranged to establish a telecommunication connection to the data system of the footwear manufacturer,
the order details comprise at least customer identification information, identification information on the footwear to be manufactured, and feet measurement information,
the first terminal is arranged to establish a telecommunication connection to a data system of the footwear manufacturer and to store said customer identification information and said feet measurement information in a customer database located in the data system of the footwear manufacturer, and
the telecommunication system further comprises software means for transmitting the identification information specified by the customer on the footwear to be manufactured through the telecommunication connection established by said first or said second terminal to said data system.

6. A telecommunication system as claimed in claim 5, wherein
said data system comprises a last database comprising essential information on last models to be manufactured,
said first terminal is arranged to compare the feet measurement information received from the foot scanner to the last models in the last database, and
said first terminal is arranged alternatively to
store the information on a suitable last model in the customer database in response to the fact that the last database comprises a last model to match said feet measurement information, or
control the data system to define a new last model and to store the information on the new last model in the customer database and in the last database in response to the fact that no last model is found in the last database to match said feet measurement information.

7. A telecommunication system as claimed in claim 5, wherein
said first and said second terminals are arranged to present alternative identification information on the footwear to be manufactured to the customer for the specification.

8. A telecommunication system as claimed in claims 5, wherein
said second terminal is arranged to establish a telecommunication connection to the data system of the footwear manufacturer through a public telecommunication network, such as the Internet.
